(19) United States
(12) Patent Application Publication
(10) Pub. No.: US 2010/0073579 A1
(43) Pub. Date: Mar. 25, 2010

(54) OPTICAL MEMBER, DISPLAY DEVICE USING THE OPTICAL MEMBER AND MOVABLE BODY USING THE DISPLAY DEVICE

(75) Inventors: Naotada Okada, Kanagawa-ken (JP); Kazuo Horiuchi, Kanagawa-ken (JP); Haruhiko Okumura, Kanagawa-ken (JP); Takashi Sasaki, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/563,412

(22) Filed: Sep. 21, 2009

(30) Foreign Application Priority Data
Sep. 25, 2008 (JP) 2008-246649

(51) Int. Cl. H04N 9/31; G02B 3/00; H01J 3/14

(52) U.S. Cl. 348/744; 359/653; 250/216; 348/E09.025

(57) ABSTRACT

There is provided an optical member comprising: a first optical layer having: a first main face formed with a concave section having a concave curved surface, and a plurality of convex ridges having concave curved surfaces provided in concentric circular fashion around said concave section; and a second main face formed with: a convex section having a convex curved surface that is provided facing the concave section and constituting a second main face facing the first main face; and a plurality of convex ridges having convex curved surfaces provided facing the plurality of convex ridges having the concave curved surface, provided in concentric circular fashion around the convex section; and a second optical layer provided on the first main face of the first optical layer; and a third optical layer provided on the second main face of the first optical layer; wherein the refractive index of the first optical layer is higher than the refractive index of the second optical layer and is higher than the refractive index of the third optical layer.

### CROSS-REFERENCE TO RELATED APPLICATION

This application claims benefit of priority from Japanese Application No. JP 2008-246649 filed Sep. 25, 2008, the entire contents of which are incorporated by reference herein.

### BACKGROUND OF THE INVENTION

1. Field of the Invention

The present invention relates to an optical member, a display device using this optical member, and a movable body using this display device.

2. Description of the Related Art

So-called head-up displays (HUD) are known in which, using a display device, various types of information are displayed on the windshield of a movable body such as a vehicle or aircraft, so that the video information thereof can be observed by the driver or pilot combined with an image of the external background field of view.

Due to the need to carry the display device in a movable body such as a vehicle or aircraft, in such head-up displays, miniaturization of the display device is demanded.

In general, the windshield of a movable body has a small curvature dimension and does not have a curvature dimension suited to the projection of an image of high display brightness. This leads to the problem that if, in order to project an image of high display brightness, a large optical system (such as for example a large concave mirror) is provided, the display device becomes bulky.

Accordingly, techniques have been proposed for providing on the windshield various types of optical member equipped with a half-mirror function, such as for example Laid-open Japanese Patent Application No. H. 11-271665 (hereinbelow referred to as Patent Reference 1).

In this case, projection of an image of high display brightness can be achieved by increasing the curvature dimension in the reflective portion by providing on the windshield an optical member having a concave surface. As a result, reduction in the size of the optical system can be achieved, with consequent reduction in size of the display device.

However, when the external background field of view image is viewed through such an optical member, the fresh problem is created that the image of the background field of view appears distorted.

### SUMMARY OF THE INVENTION

The present invention was made in order to overcome the above problems, its object being to provide an optical member, a display device using this optical member and a movable body using this display device, whereby distortion of the image of the background field of view can be suppressed.

In order to achieve the above object, an optical member according to the present invention, a display device utilizing this optical member, and a movable body utilizing this display device are constructed as follows. Specifically, there is provided an optical member comprising:

(1) a first optical layer having:
(a) a first main face formed with a concave section having a concave curved surface, and a plurality of convex ridges having concave curved surfaces provided in concentric circular fashion around aforementioned concave section; and
(b) a second main face formed with: a convex section having a convex curved surface that is provided facing aforementioned concave section and constituting a second main face facing aforementioned first main face; and a plurality of convex ridges having convex curved surfaces provided facing the plurality of convex ridges having aforementioned concave curved surface, provided in concentric circular fashion around aforementioned convex section; and

(2) a second optical layer provided on the first main face of aforementioned first optical layer; and

(3) a third optical layer provided on the second main face of aforementioned first optical layer,

wherein a refractive index of aforementioned first optical layer is higher than a refractive index of aforementioned second optical layer and is higher than a refractive index of aforementioned third optical layer.

According to a further aspect of the present invention, there is provided an optical member comprising:

(4) a fourth optical layer having: a main face formed with a concave section having a concave curved surface, and a plurality of convex ridges having concave curved surfaces provided in concentric circular fashion around aforementioned concave section;

(5) a semi-transparent layer provided on aforementioned main face of aforementioned fourth optical layer; and

(6) a fifth optical layer provided on the main face on the opposite side to aforementioned fourth optical layer of aforementioned semi-transparent layer,

wherein the refractive index of aforementioned fourth optical layer and the refractive index of aforementioned fifth optical layer are substantially the same.

According to a further aspect of the present invention, there is provided a display device comprising: aforementioned optical member and a projection unit that directs optical flux onto aforementioned optical member.

According to a further aspect of the present invention, there is provided a movable body comprising: aforementioned display device and a projection plate onto which video information is projected by aforementioned display device.

According to the present invention, there are provided an optical member, display device and movable body whereby distortion of an image of the background field of view can be suppressed.

### BRIEF DESCRIPTION OF THE DRAWINGS

FIG. 1A and FIG. 1B are diagrams showing by way of example an optical member according to a first embodiment.

FIG. 2A and FIG. 2B are diagrams showing by way of example an optical member according to a comparative example.

FIG. 3 is a diagram showing by way of example the action of the optical member.

FIG. 4A and FIG. 4B are diagrams showing by way of example an optical member according to a second embodiment.

FIG. 5 is a cross-sectional diagram showing by way of example the action of the optical member.

FIG. 6 is a diagram showing by way of example a display device according to a third embodiment.

FIG. 7 is a diagram showing by way of example a display device according to a fourth embodiment.

FIG. 8 is a diagram showing by way of example a display device according to a fifth embodiment.

FIG. 9 is a diagram showing by way of example a display device according to a sixth embodiment.

FIG. 10 is a diagram showing by way of example a display device according to a seventh embodiment.

FIG. 11 is a diagram showing by way of example a movable body according to the present embodiment.

### DETAILED DESCRIPTION OF THE PREFERRED EMBODIMENTS

An embodiment of the present invention is described below with reference to the drawings. In the drawings, similar structural elements are given the same reference numerals and further detailed description thereof is dispensed with.

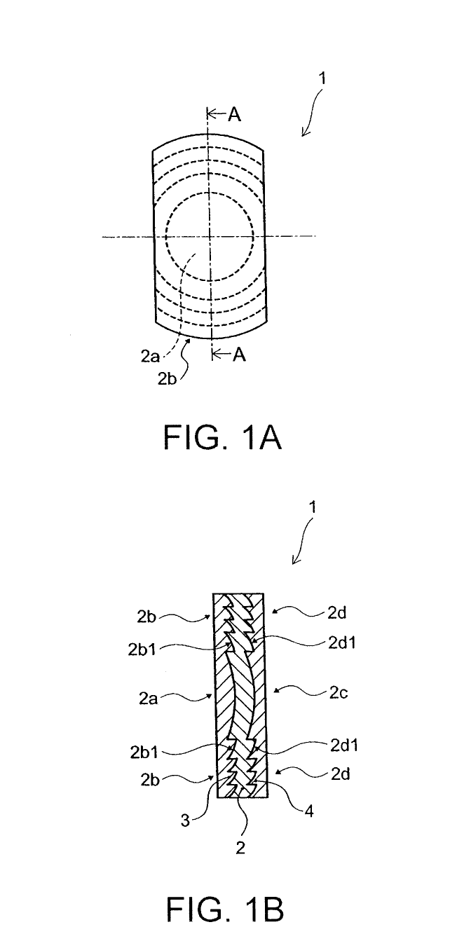

FIG. 1A and FIG. 1B are diagrams showing by way of example an optical member according to a first embodiment. FIG. 1A is a plan view of the optical member and FIG. 1B is a cross-sectional view along the line A-A in FIG. 1A.

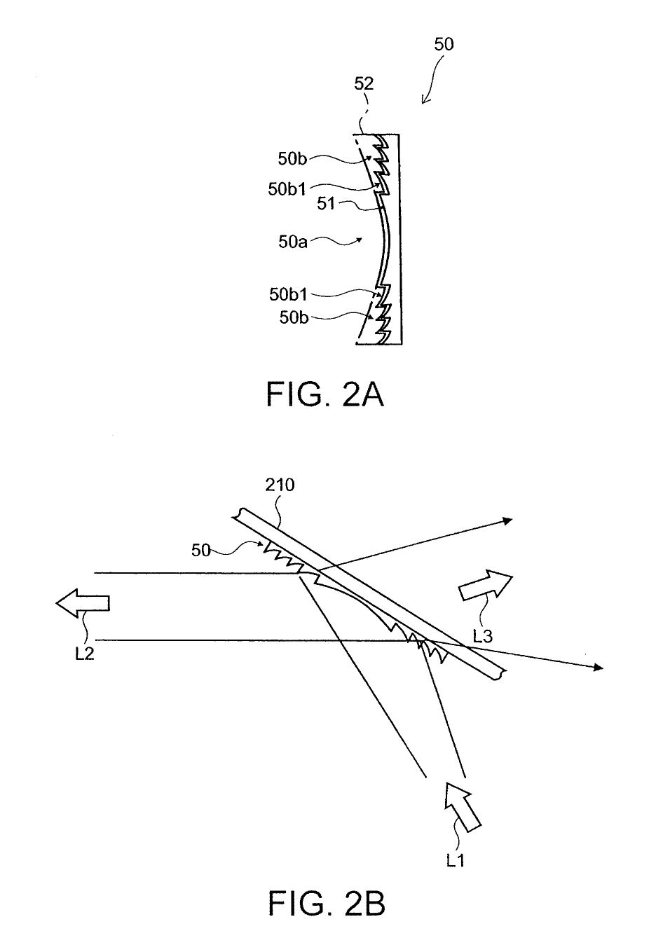

FIG. 2A and FIG. 2B are diagrams showing by way of example an optical member according to a comparative example. FIG. 2A is a cross-sectional diagram showing by way of example an optical member according to a comparative example and FIG. 2B is a cross-sectional diagram showing by way of example the action when the optical member according to the comparative example is provided on a projection plate.

First of all, an optical member according to a comparative example will be described.

As shown in FIG. 2A, a concave section 50a and a plurality of convex ridges 50b are provided on one of the main faces of an optical member 50 presenting a thin plate shape. The optical members 50 (concave section 50a and convex ridges 50b) are formed of transparent or semitransparent organic material or inorganic material or the like, so as to be capable of transmitting incoming optical flux.

The concave section 50a is provided in substantially the middle of the optical member 50. Also, the convex ridges 50b are provided in concentric circular fashion around the concave section 50a. Also, a concave curved surface is provided on a main face of the concave section 50a and the convex ridges 50b. Also, a semitransparent section 51 is provided presenting a thin film shape such as to cover the concave section 50a and convex ridges 50b. Consequently, the optical member 50 reflects part of the optical flux that is incident on the main face and also transmits part thereof.

The concave section 50a presents a surface shape that is the same as the central portion of an optical member 52 having a concave curved surface. Consequently, the main face (concave curved face) of the concave section 50a has substantially the same curvature dimension as the corresponding portion of the optical member 52. Also, the convex ridges 50b have shapes identical with the shapes that would be produced by cutting the optical member 52 in concentric circular fashion and placing these surface portions of the optical member 52, cut thus in concentric circular fashion, next to each other on a plane. Consequently, the concave curved face 50b1 of the convex ridges 50b also has substantially the same curvature dimension as the corresponding portion of the optical member 52.

In other words, the optical member 50 represents the result of reducing the thickness, without changing the optical effect, of the optical member 52 having a concave curved face. The optical member 50 therefore functions as a concave mirror by reflecting incident light by means of the semitransparent section 51 provided on its main face. Also, the optical member 50 functions as a concave lens when incident light is transmitted through the semitransparent section 51 provided on its main face.

Next, an example of the action when the optical member 50 is provided on the projection plate 210 will be described.

FIG. 2B shows an example of a case where optical flux from a projection unit, not shown, is incident on the optical member 50 provided on the projection plate 210 (such as for example the windshield of a movable body).

As shown in FIG. 2B, the optical flux L1 emitted from a projection unit, not shown, is incident onto the optical member 50. Part of this optical flux is then reflected by the semitransparent section 51 provided at the front face of the optical member 50, and becomes optical flux L2. This optical flux L2 is focused, since the optical member 50 has the function of a concave mirror, as described above. Its display brightness can therefore be increased. In this way, the power consumption of the projection unit, not shown, can be reduced and the life of the light source can be lengthened.

Thus, when the optical member 50 is employed in a head-up display, the observer (for example, the driver etc) becomes able to observe the image of the external background field of view through the optical member 50. However, since the optical member 50 also has a concave lens function, as described above, the optical flux that is transmitted therethrough is refracted. As a result, the direction of the transmitted optical flux L3 is deflected by a prescribed angle from the direction of incidence. This is most marked at the convex ridges 50b. When the optical flux transmitted through the optical member 50 is deflected by a prescribed angle from the direction of incidence in this way, the image of the external background field of view appears distorted. Such distortion of the image of the external background field of view may severely affect recognizability.

Next, an example of an optical member 1 according to a first embodiment will be described, returning to FIG. 1A and FIG. 1B.

As shown in FIG. 1B, an optical layer 2, an optical layer 3 and an optical layer 4 are provided on the optical member 1 that presents a thin plate shape.

The optical layer 3 is provided adhering to one main face of the optical layer 2. Also, the optical layer 4 is provided adhering to the main face opposite to this.

On one main face of the optical layer 2, there are provided a concave section 2a and a plurality of convex ridges 2b.

Also, as shown in FIG. 1A, the concave section 2a is provided in substantially the middle of the optical member 1. The concave section 2a presents a substantially circular shape in plan view. Also, the convex ridges 2b are provided in concentric circular shape around the concave section 2a. Also, a concave curved face is provided on the main face of the concave section 2a and convex ridges 2b.

The concave section 2a presents the same surface shape as the middle portion of the optical member 52 having a concave curved face described above. Consequently, the main face (concave curved face) of the curved section 2a has substantially the same curvature dimension as the corresponding portion of the optical member 52. Also, the convex ridges 2b have shapes identical with the shapes that would be produced by cutting the optical member 52 described above in concentric circular fashion and placing these surface portions of the optical member 52, cut thus in concentric circular fashion, next to each other on a plane. Consequently, the main face 2b1 of the convex ridges 2b also has substantially the same curvature dimension as the corresponding portion of the optical member 52. Thus, in effect, the concave section 2a and convex ridges 2b are reduced in thickness without changing the optical action of the optical member 52 having the concave curved surface.

Consequently, at the side where the concave section 2a and convex ridges 2b are provided, the optical member functions as a concave mirror when reflecting incident optical flux and functions as a concave lens when transmitting incident optical flux.

On the main face on the side opposite to the main face where the concave section 2a and convex ridges 2b are provided, there are provided a convex section 2c and a plurality of convex ridges 2d. The convex section 2c presents a substantially circular shape in plan view. Also, the convex section 2c has the same diameter dimension as the concave section 2a and is provided facing the concave section 2a.

The convex ridges 2d are provided in concentric circular fashion around the convex section 2c. Also, the convex ridges 2d have the same dimension in the diameter direction as the convex ridges 2b, and are provided facing the convex ridges 2b.

Specifically, the optical layer 2 comprises: a concave section 2a having a concave curved surface provided on one main face; a plurality of convex ridges 2b having a concave curved surface provided in concentric circular shape around the concave section 2a; a convex section 2c having a convex curved surface provided facing the concave section 2a on the main face on the side facing the main face where these are provided; and a plurality of convex ridges 2d having a convex curved surface provided facing the plurality of convex ridges 2b having a concave curved surface that are provided in concentric circular shape around the convex section 2c.

Also, the surface shape of the convex section 2c and convex ridges 2d and the surface shape of the concave section 2a and convex ridges 2b are symmetrical. Specifically, the main face of the convex section 2c is a convex curved surface and has substantially the same curvature dimension as the main face of the concave section 2a. Also, the main face 2d1 of the convex ridges 2d is a convex curved surface, having substantially the same curvature dimension as the main face 2b1 of the convex ridges 2b. In other words, the curvature dimensions of the concave curved surface and the convex curved surface of the portions provided in mutually facing positions are substantially the same.

The optical layer 2, optical layer 3 and optical layer 4 are formed of transparent or semitransparent organic material or inorganic material etc and are such as to be capable of transmitting incident optical flux. The refractive index of the optical layer 2 is higher than the refractive index of the optical layer 3 and is higher than the refractive index of the optical layer 4. In this case, the refractive index of the optical layer 3 and the refractive index of the optical layer 4 may be substantially the same.

The optical layer 2 may be made for example of high refractive index resin. Such a material may be produced by for example mixing microparticles of particle diameter no more than 50 nm of TiO₂ or ZrO₂ of high refractive index with epoxy resin. With such a material, a refractive index of about 1.8 to 2.2 can be obtained. Material of high refractive index such as TiO₂ or ZrO₂ may also be deposited on the surface of the optical layer 2 by a method such as sputtering. It may be noted that, although the case where microparticles of TiO₂ (refractive index 2.3) or ZrO₂ (refractive index 2.0) of high refractive index were employed was described by way of example, there is no restriction to this. For example, various types of material of high refractive index, such as ITO (indium tin oxide) (refractive index 1.85), HfO₂ (Hafnium Oxide) (refractive index 1.95) or Ta₂O₅ (refractive index 2.1) may be employed. Also, organotitanium materials etc may be employed.

The optical layer 3 and the optical layer 4 can be made of various types of transparent or semitransparent materials such as porous silica material, polycarbonate (PC), polyvinyl alcohol (PVA), polyarylate (PA or PAR), polysulfone (PSF), or polyolefin (PO). However, there is no restriction to these, and a suitable selection could be made of transparent materials or semitransparent materials having lower refractive index than the optical layer 2.

If the refractive index of the optical layer 2 is made higher than the refractive index of the optical layer 3, part of the optical flux that is incident through the optical layer 3 can be reflected at the boundary surface between the optical layer 2 and the optical layer 3. As a result, the side where the concave section 2a and convex ridges 2b of the optical layer 2 are provided has the function of a concave mirror when the incident optical flux is reflected. On the other hand, when the incident optical flux is transmitted, it has the function of a concave lens.

In contrast, the side of the optical layer 2 where the convex section 2c and convex ridges 2d are provided has the function of a convex lens in respect of the transmitted optical flux.

Next, the action in the case where the optical member 1 is provided on a projection plate 210 will be described by way of example.

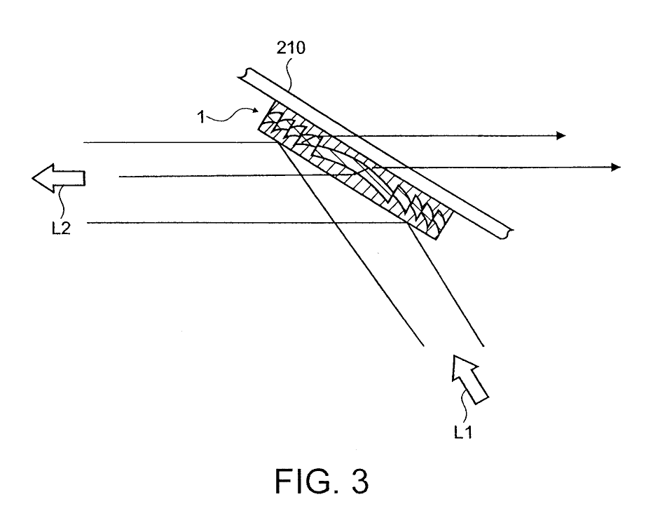

FIG. 3 is a cross-sectional diagram showing by way of example the action of the optical member 1.

FIG. 3 shows by way of example the case where the optical member 1 is provided on the projection plate 210 (for example the windshield of a movable body), and the optical flux from a projection unit, not shown, is incident thereon.

As shown in FIG. 3, the optical flux L1 that is emitted from the projection unit, not shown, is incident on the optical member 1. Part thereof is then reflected at the boundary surface between the optical layer 2 and the optical layer 3, becoming optical flux L2. In this process, the optical layer 2 has the function of a concave mirror at the side where the concave section 2a and ridges 2b are provided, so the optical flux L2 is focused.

When the optical flux is transmitted through the side where the concave section 2a and ridges 2b of the optical layer 2 are provided, since the optical layer 2 functions as a concave lens, the optical flux that is transmitted therethrough is refracted. However, when the optical flux is transmitted through the side where the convex section 2c and convex ridges 2d of the optical layer 2 are provided, since the optical layer 2 functions as a convex lens, the optical flux is refracted in the direction opposite to the case where it functions as a concave lens. In this case, the side (side where the concave section 2a and convex ridges 2b are provided) that functions as a concave lens and the side (side where the convex section 2c and convex ridges 2d are provided) that functions as a convex lens have substantially the same curvature dimension in their opposing portions, so the optical flux that is transmitted is refracted in a direction in which these cancel each other out.

As a result, the direction of the optical flux that is incident on the optical member 1 and the direction of the optical flux that is emitted from the optical member 1 can be made to be substantially parallel. Also, the thickness dimension of the optical layer 2 can be made small, so the optic axis of the optical flux that is incident on the optical member 1 and the optic axis of the optical flux that is emitted from the optical member 1 can be made to show little displacement.

In this embodiment, since a concave mirror function is provided at the side where the concave section 2a and convex ridges 2b of the optical layer 2 are provided, the reflected optical flux L2 can be focused. Consequently, display brightness can be increased. Also, reduction of the power consumption of the projection unit, not shown, and lengthening of the life of the power source can be achieved.

Also, since the side (side where the concave section 2a and convex ridges 2b are provided) that functions as a concave lens and the side (side where the convex section 2c and convex ridges 2d are provided) that functions as a convex lens have substantially the same curvature dimension at the opposed portions, the optical flux can be refracted in mutually canceling directions. Consequently, distortion of the image of the external background field of view can be suppressed. Also, recognizability of the image can be improved.

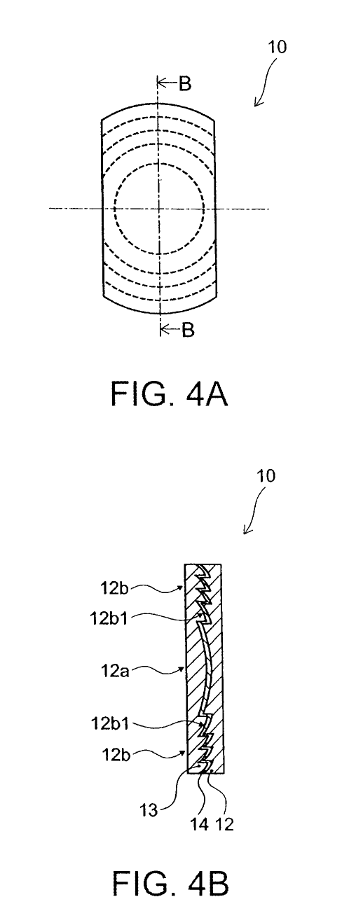

FIG. 4A and FIG. 4B are diagrams illustrating by way of example an optical member according to a second embodiment. FIG. 4A is a plan view of the optical member and FIG. 4B is a cross-sectional view along the arrows B-B in FIG. 4A.

As shown in FIG. 4B, an optical layer 12, optical layer 13, and semi-transparent layer 14 are provided on an optical member 10 that presents a thin plate shape.

A concave section 12a and a plurality of convex ridges 12b are provided on one main face of an optical layer 12.

Also, as shown in FIG. 4A, a concave section 12a is provided in substantially the middle of the optical member 10. This concave section 12a presents a substantially circular shape in plan view. Also, convex ridges 12b are provided in concentric circular fashion around the concave section 12a. Also, a concave curved surface is provided on the main face of the concave section 12a and convex ridges 12b.

The concave section 12a presents a surface shape that is the same as the middle portion of the optical member 52 having a concave curved surface described above. Consequently, the main face (concave curved surface) of the concave section 12a has substantially the same curvature dimension as the corresponding portion of the optical member 52. Also, the convex ridges 12b have the same shape as would be produced by cutting the optical member 52 described above in concentric circular shape and arranging the surface portions of the optical member 52 that has thus been cut into concentric circular shapes next to each other on a plane. Consequently, the main face 12b1 of the convex ridges 12b has substantially the same curvature dimension as the corresponding portion of the optical member 52. In other words, the concave section 12a and convex ridges 12b can be reduced in thickness without changing the optical effect of the optical member 52 having the concave curved surface.

Consequently, when the incident optical flux is reflected, the side where the concave section 12a and convex ridges 12b are provided functions as a concave mirror and, when the incident optical flux is transmitted, functions as a concave lens.

A semitransparent layer 14 is provided so as to cover the concave section 12a and convex ridges 12b. The semitransparent layer 14 can reflect part of the incident optical flux and can transmit part of the incident optical flux. This semitransparent layer can be for example a multilayer film of metal or dielectric, or can be produced by deposition of optically reflective material (such as for example aluminum) in the form of a thin film (for example by deposition using a technique such as sputtering, in a film thickness of about 100 nm to 500 nm). However, there is no restriction to these and any material that is capable of reflecting part of the incident optical flux and transmitting part thereof may be appropriately selected.

The optical layer 13 is provided adhering to the semitransparent layer 14.

Specifically, the optical member 10 comprises: an optical layer 12 provided with a concave section 12a having a concave curved surface provided on one main face and a plurality of convex ridges 12b having a concave curved surface provided in concentric circular fashion around the concave section 12a; a semitransparent layer 14 provided on the main face where the concave section 12a and convex ridges 12b are provided; and an optical layer 13 provided on the main face on the side opposite to the side where the optical layer 12 of the semitransparent layer 14 is provided.

The optical layer 12 and optical layer 13 are formed of for example transparent or semitransparent organic material or inorganic material so as to be capable of transmitting incident optical flux. Also, the refractive index of the optical layer 12 and the refractive index of the optical layer 13 are substantially the same.

The optical layer 12 and the optical layer 13 can be made of various types of transparent or semitransparent materials such as porous silica material, polycarbonate (PC), polyvinyl alcohol (PVA), polyarylate (PA), polysulfone (PSF), or polyolefin (PO). However, there is no restriction to these, and this choice could be altered as appropriate.

In this case, the optical layer 12 and the optical layer 13 may be formed of the same material, so that the refractive index of the optical layer 12 and the refractive index of the optical layer 13 are substantially the same. However, so long as the refractive index of the optical layer 12 and the refractive index of the optical layer 13 are substantially the same, the optical layer 12 and optical layer 13 may be formed of different materials.

Next, the action when the optical member 10 is provided on the projection plate 210 will be described by way of example.

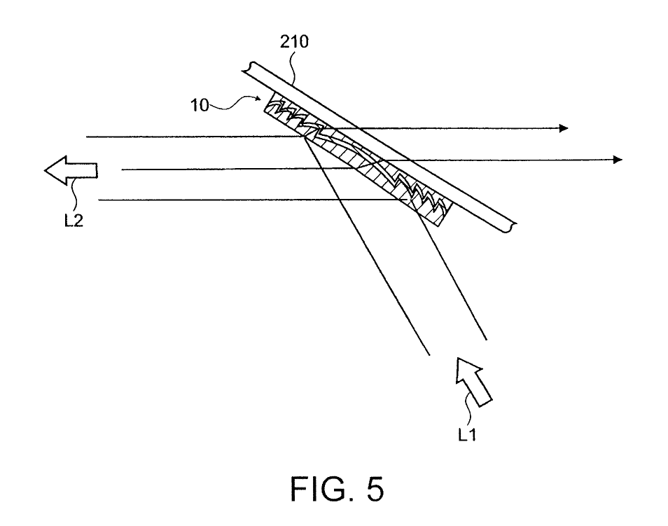

FIG. 5 is a cross-sectional diagram illustrating by way of example the action of an optical member 10.

FIG. 5 shows by way of example the case where the optical member 10 is provided on the projection plate 210 (for example, the windshield of a movable body), so that optical flux from a projection unit, not shown, can be directed onto it.

As shown in FIG. 5, optical flux L1 emitted from the projection unit, not shown, is directed onto the optical member 10. Part of this optical flux L1 that has passed through the optical layer 13 is then reflected at the semitransparent layer 14, becoming optical flux L2. Since, in this process, the optical layer 12 functions as a concave mirror at the side where the concave section 12a and convex ridges 12b are provided, the optical flux L2 is focused.

Since the refractive index of the optical layer 12 and the refractive index of the optical layer 13 are substantially the same, refraction of the optical flux passing through the optical layer 12 and the optical layer 13 is suppressed. The optical flux that is incident from the optical layer 12 or optical layer 13 can therefore pass substantially straight through the interior of the optical member 10.

As a result, the direction of the optical flux that is incident on the optical member 10 and the direction of the optical flux that is emitted from the optical member 10 can be made to be substantially parallel. Also, the thickness dimension of the optical member 10 can be made small, so the optic axis of the optical flux that is incident on the optical member 10 and the optic axis of the optical flux that is emitted from the optical member 10 can be made to show little displacement.

In this embodiment, since a concave mirror function is provided at the side where the concave section 12a and convex ridges 12b of the optical layer 12 are provided, the reflected optical flux L2 can be focused. Consequently, display brightness can be increased. Also, reduction of the power consumption of the projection unit, not shown, and lengthening of the life of the power source can be achieved.

Also, since the refractive index of the optical layer 12 and the refractive index of the optical layer 13 are substantially the same, the optical flux that is incident from the optical layer 12 or optical layer 13 can pass substantially straight through the interior of the optical member 10. Also, the thickness dimension of the optical member 10 can be made small. As a result, the direction of the optical flux that is incident on the optical member 10 and the direction of the optical flux that is emitted from the optical member 10 can be made to be substantially parallel. Also, the displacement of the optic axis of the incident optical flux and the optic axis of the emitted optical flux can be made small. As a result, distortion of the image of the external background field of view can be suppressed. Also, recognizability of the image can be improved.

Next, a display device according to this embodiment will be described by way of example.

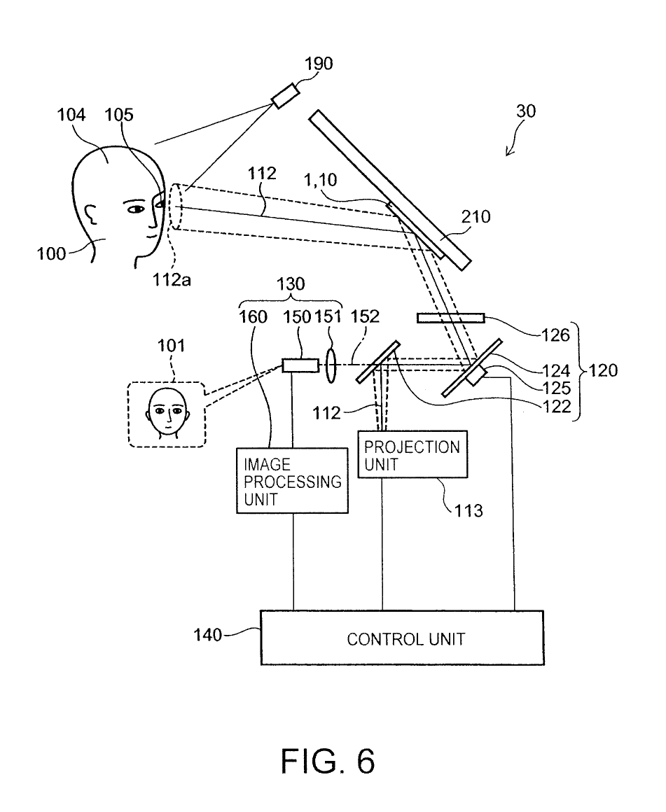

FIG. 6 is a diagram illustrating by way of example a display device according to a third embodiment.

As shown in FIG. 6, a display device 20 according to this embodiment comprises a projection unit 113, an optical flux control unit 120, an image detection unit 130 and a control unit 140. Also, on a projection plate 210, an optical member 1 (or optical member 10) according to this embodiment is provided. Video information is contained in the optical flux 112 that is generated by the projection unit 113.

The projection unit 113 emits optical flux 112 containing video information. Also, the projection unit 113 projects various types of video information such as movement information in the form of an optical image. As the projection unit 113, there is shown by way of example a liquid-crystal projector or digital light processing (DLP) projector. A liquid-crystal projector may comprise for example a liquid-crystal panel and a light source. The video information is projected as an optical image by passing the optical flux from the light source through the liquid-crystal panel. Also, a digital light processing projector may comprise a digital micromirror device (DMD) and a light source. Also, video information may be projected as an optical image by reflecting the optical flux from the light source by minute mirrors that are moved independently and are provided on the silicon substrate. However, the projection unit 113 is not restricted to the illustrated example and any type of projection unit may be employed as appropriate that is capable of converting an electrical signal to an optical image.

The optical flux control unit 120 comprises a first mirror 122, second mirror 124, lens 126 and drive unit 125. The optical flux control unit 120 controls the direction of the optical flux 112, so that the optical flux 112 is directed onto a position at a prescribed part of the observer 100 (in particular the position of the observer's eye 105).

Also, a first mirror 122 reflects part of the incident optical flux and transmits part thereof. It may be arranged to reflect visible light and to transmit infrared light.

A second mirror 124 converts the direction of the optical flux 112 by reflecting the reflected light from the first mirror 122.

Also, the drive unit 125 is connected with the second mirror 124. Also, the drive unit 125 can change the position of the second mirror 124. Thus it is possible to change the position of the display region 112a by changing the position of the second mirror 124. For example, by changing the angle of the second mirror 124, the position of the display region 112a can be changed in the left/right or up/down direction.

The lens 126 focuses the reflected light from the second mirror 124. The lens 126 is not necessarily essential but may be suitably provided if required.

Also, the positions of the projection unit 113, the first mirror 122, second mirror 124 and lens 126 are arranged to be capable of being individually adjusted for example on installation or maintenance.

The image detection unit 130 comprises an image pickup unit 150, adjustment lens 151 and image processing unit 160.

The image pickup unit 150 picks up an image 101 of the observer 100 through the optical member 1 (or optical member 10) provided on the projection plate 210, lens 126, second mirror 124 and first mirror 122. The image pickup unit 150 may be exemplified by for example a CCD (charge coupled device) camera or CMOS (complementary metal oxide semiconductor) sensor. However, there is no restriction to these, and any image pickup unit that is capable of converting video information to an electrical signal may be selected as appropriate. Also, as the first mirror 122, preferably a mirror is employed that reflects visible light but transmits infrared light. Also, as the image pickup unit 150, preferably an image pickup unit is employed that is capable of picking up an image 101 of the observer 100 using infrared light. With such a construction, unwanted noise in the image can be reduced.

The adjustment lens 151 is provided between the image pickup unit 150 and first mirror 122. The adjustment lens 151 is used to adjust the magnitude and sharpness of focus of the image by focusing the optical flux that is emitted from the first mirror 122. The adjustment lens 151 is not necessarily essential but may be suitably provided if required.

By performing image processing, the image processing unit 160 analyzes the position of a specified part associated with the observer 100, picked up by the image pickup unit 150. For example, it may be arranged for the image processing unit to analyze the position of the head, in particular the eyes, of the observer 100 by specifying the position of characteristic points on the face of the observer 100, such as for example the two eyeballs, the position of the nose or the position of the mouth. By performing image processing, the position of a specified part of the observer 100 (in particular the position of the eyes 105) can be ascertained.

The projection unit 113, image processing unit 160 and drive unit 125 are electrically connected with the control unit 140.

The control unit 140 controls the drive unit 125 in accordance with the position (in particular the position of the eyes 105) of a specific part of the observer 100 analyzed in the image processing unit 160. Specifically, optical flux 112 is directed onto the position (in particular the position of the eyes 105) of a specific part of the observer 100 by altering the angle etc of the second mirror 124 by controlling the drive unit 125.

Thus the display device 20 is provided with an image pickup unit 150 that picks up an image 101 of the observer 100 and an optical flux control unit 120 that directs the optical flux 112 onto the position of a specified part of the observer 100 by using the image 101 that is thus picked up.

In this process, if the display region 112a can be restricted to the portion of the eye 105 of the observer 100, display brightness can be increased and power consumption lowered and longer life of the power source achieved. However, in order to restrict the display region 112a to the portion of the eye 105, it is necessary to direct the optical flux 112 correctly onto the position of the eye 105 of the observer 100. In particular, if the display region 112a is a narrow range representing one eye only, positional alignment of the display region 112a with this one eye is vital.

With this embodiment, the position of a specified part (in particular, the position of the eye 105) of the observer 100 can be analyzed and the optical flux 112 can be directed in accordance therewith. Precise positional alignment of the display region 112a and the position of a specified part (in particular the position of the eye 105) of the observer 100 can therefore be achieved, in spite of the narrowness of the range of the display region 112a. Also, even when the head of the observer 100 moves vertically or horizontally, the position of incidence (position of the display region 112a) of the optical flux 112 can track such movement.

Also, the control unit 140 emits optical flux 112 containing video information to the projection unit 113.

Also, an image display unit, not shown, can be electrically connected with the control unit 140. A crossbar or the like can also be displayed indicating for example the center of the display region 112a, on the display screen of the image display unit, not shown. In this way, positional alignment of the position of a specified part of the observer 100 (for example, the position of one eye 105) and the position of the display region 112a can easily be achieved.

The projection plate 210 may be for example the windshield of a movable body such as an automobile. Also, an optical member 1 as described above (or optical member 10) may be provided on the projection plate 210. In this case, this optical member is provided facing in the direction from which the optical flux from the projection unit 113 is incident with respect to the main face on the side where the concave curved surface of the optical member is provided. For example, in the case of the optical member 1, this optical member is arranged such that the optical flux from the projection unit 113 is incident with respect to the main face on the side where the concave section 2a and convex ridges 2b are provided. Also, in the case of the optical member 10, this optical member is arranged such that the optical flux from the projection unit 113 is incident with respect to the main face on the side where the concave section 12a and convex ridges 12b are provided.

Also, a head-up display (HUD) can be constituted by mounting the display device 20 on a movable body such as an automobile and using the windshield as the projection plate 210.

Next, the action of a display device 20 according to this embodiment will be described by way of example. First of all, as shown in FIG. 6, optical flux 112 is emitted from the projection unit 113 in accordance with an electrical signal from the control unit 140. The optical flux 112 emitted from the projection unit 113 contains video information.

The optical flux 112 that is emitted from the projection unit 113 is directed onto the second mirror 124 by altering the direction of this optical flux using the first mirror 122. The optical flux 112 that is directed onto the second mirror 124 is emitted towards the lens 126 by being reflected. The optical flux 112 that is directed onto the lens 126 is focused and is thus directed onto the optical member 1 (or optical member 10). At this point, the optical flux is directed onto the main face of the optical member 1 (or optical member 10) on the side where the concave curved surface is provided. Part of the optical flux 112 that is directed onto the optical member 1 (or optical member 10) is reflected, so that it reaches the display region 112a.

At this juncture, the position of the second mirror 124 is controlled by the drive unit 125 by using an electrical signal from the control unit 140. This is done in such a way that the position of the display region 112a is made to coincide with the position of a specific part of the observer 100 (in particular, the position of one eye 105).

Also, when the position of the specified part of the observer 100 (in particular, the position of one eye 105) is displaced, the position of the second mirror 124 is controlled in accordance with an electrical signal from the control unit 140. At this juncture, the position of the specified part of the observer 100 (in particular, the position of one eye 105) is analyzed by the image detection unit 130 described above. Specifically, an image 101 of the observer 100 is picked up by the image pickup unit 150 through the optical member 1 (or optical member 10) provided on the projection plate 210, the lens 126, second mirror 124, first mirror 122 and adjustment lens 151. The data of the image that is picked up by the image pickup unit 150 is subjected to image processing by the image processing unit 160. The position of the second mirror 124 is then controlled in accordance with the analysis data obtained by performing this image processing.

It should be noted that various types of projection unit 113 could be employed apart from the illustrated example of a projector. For example, projection units can be employed produced by combining various types of light source such as a laser or LED (light emitting diode) or halogen lamp with an optical element such as a movable mirror or MEMS (Micro-ElectroMechanical System) used to scan the optical flux generated by the light source. Also, it may be arranged to combine an optical switch such as an LCD (liquid crystal display) with light sources of various types. Also, displays based on various types of system may be employed, such as a CRT (cathode ray tube) or vacuum fluorescent display (VFD), PDP (plasma display panel), EL (electroluminescence) display device, or organic EL display device.

Also, optical elements of various types may be employed for the optical flux control unit 120. For example, for reflection/diffraction or Semi-transmission of the optical flux, there may be employed a plane mirror, a prism, or a Fresnel lens. Also, configurations produced by the arrangement of a plurality of wave-guides (or light-guides), such as lenses of various types, apertures, lenticular sheets, holographic diffusers, diffusion screens, micro-lens arrays, graded index micro-lenses, various types of prism sheets, louver sheets, or truncated three-sided pyramids or triangular pyramids or trigonal pyramids may be employed. Also, optical elements as described above of various types may be suitably combined.

Also, the optical elements described above may be used in combination, replaced or deleted within the range of technical feasibility.

Since, in the present embodiment, the optical member 1 (or optical member 10) described above has the function of a concave mirror, it can focus the reflected optical flux 112. The display brightness can therefore be raised. Also, reduction of consumption of the projection unit 113 and increase in the life of the light source can be achieved.

Also, the direction of the optical flux 112 that is directed onto the optical member 1 (or optical member 10) and the direction of the optical flux 112 that is emitted may be made substantially parallel. Also, the optic axis of the incident optical flux 112 and the optic axis of the emitted optical flux 112 can be made to show little displacement. Consequently, distortion of the image of the external background field of view can be suppressed. Also, recognizability of the image can be improved.

Also, the position of the eye 105 of the observer 100 is analyzed by the image processing unit 160, so that the optical flux 112 can be directed onto this position. Also, when the display device 20 is provided at for example the driver's seat of an automobile, it can be arranged for the optical flux 112 to be correctly directed onto the position of the eye 105, matching the height etc of the observer (driver) 100. Also, even when the head of the observer 100 is moved vertically or to left or right, it can be arranged for the optical flux 112 to track such movement. As a result, it becomes possible to achieve continued observation of the display. Also, since the position of the display region 112a can be restricted to the portion of the eye 105, a display of high brightness and recognizability can be achieved. Reduction in the power consumption and increase in the life of the light source can also be achieved. In particular, considerable benefits can be manifested when the optical flux 111 is directed solely onto one eye 105 of the observer 100.

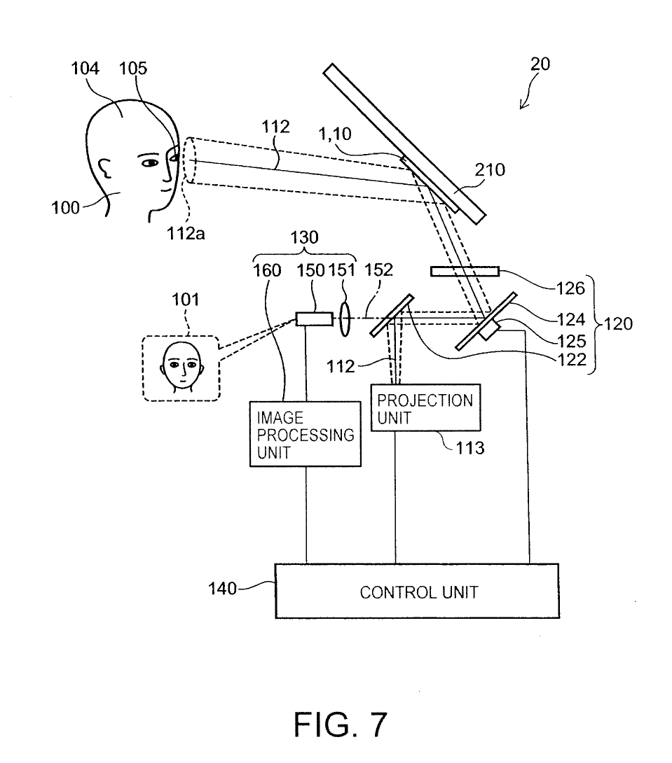

FIG. 7 is a diagram illustrating by way of example a display device according to a fourth embodiment.

As shown in FIG. 7, in the display device 30, there is additionally provided an infrared LED (light emitting diode) 190 that illuminates the observer 100. In this way, an image 101 of the observer 100 can be picked up in a stable fashion even under dark conditions such as at night.

In this way, the display device 30 can analyze the position (in particular, at the position of the eye 105) of a specified part of the observer 100 in a stable fashion under dark conditions. Optical flux 112 can thus be directed in stable fashion onto the position of a specified part (in particular, the position of the eye 105) of the observer 100. Preferably this display device 100 is employed in a head-up display (HUD) that is also used at night. As the light source used to illuminate the observer 100, various types of lamp etc may be employed, apart from infrared LEDs (light emitting diodes).

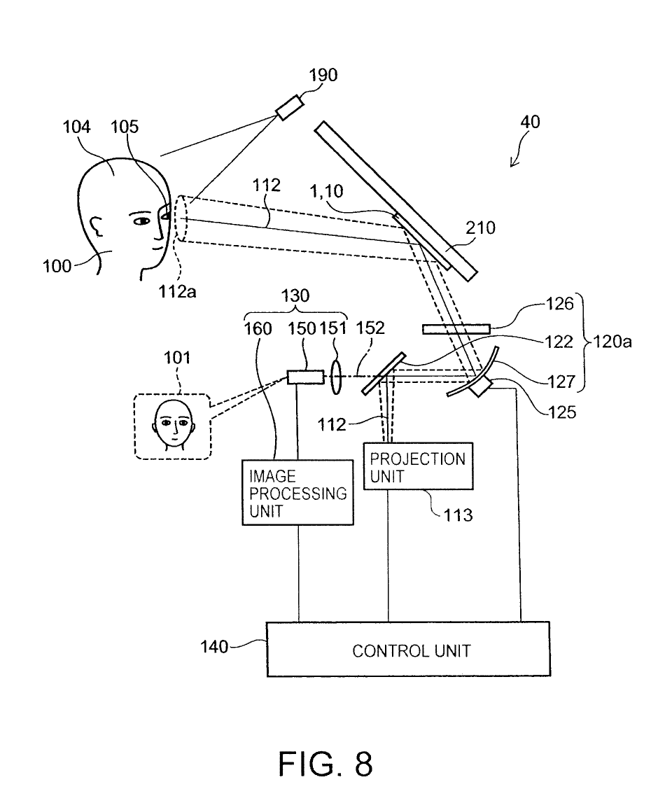

FIG. 8 is a diagram illustrating by way of example a display device according to a fifth embodiment.

As shown in FIG. 8, the display device 40 comprises a flux control unit 120a. Also, a concave surface mirror 127 is provided in the flux control unit 120a. The concave surface mirror 127 is provided in place of the second mirror 124 of the display device 30 illustrated by way of example in FIG. 7. A drive unit 125 is connected with the concave surface mirror 127. Also, it is arranged that the position of the concave surface mirror 127 can be altered by the drive unit 125. Also, the position of the display region 112a can be altered by altering the position of the concave surface mirror 127. For example, the position of the display region 112a in the left/right or vertical direction can be altered by altering the angle etc of the concave surface mirror 127. It should be noted that the position of the display region 112a could also be controlled by means of the curvature of the concave surface mirror 127. Consequently, the position control of the display region 112a can be made to be performed even more effectively. Also, the size of the display device can be reduced.

It should be noted that, since the optical member 1 (or optical member 10) described above has the function of a concave surface mirror, it is not necessarily essential to employ a concave surface mirror 127 in place of the second mirror 124. However, if a concave surface mirror 127 is employed, display of even more brightness and recognizability can be achieved.

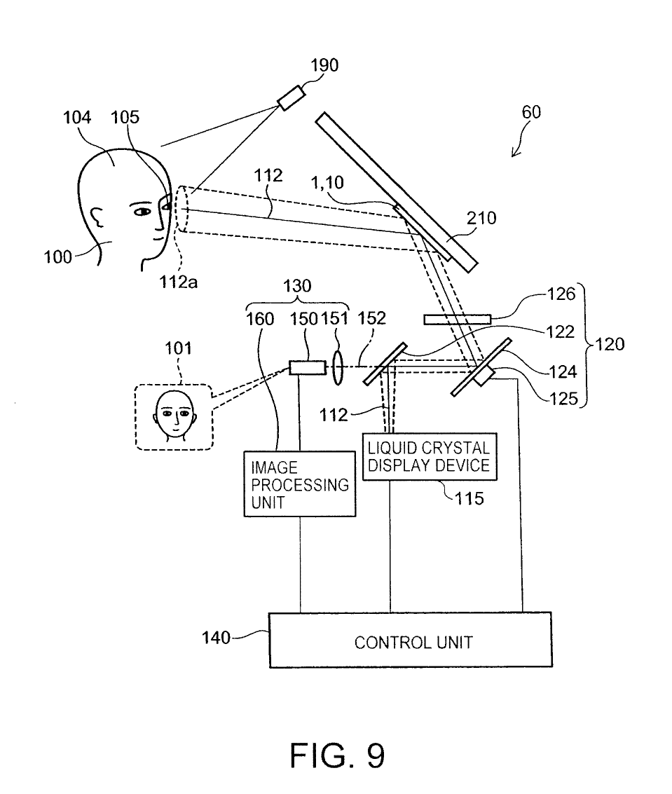

FIG. 9 is a diagram illustrating by way of example a display device according to a sixth embodiment.

As shown in FIG. 9, a liquid crystal display device 115 comprising a backlight is provided as the projection unit in the display device 60. With such a construction, the display device 60 can be reduced in size.

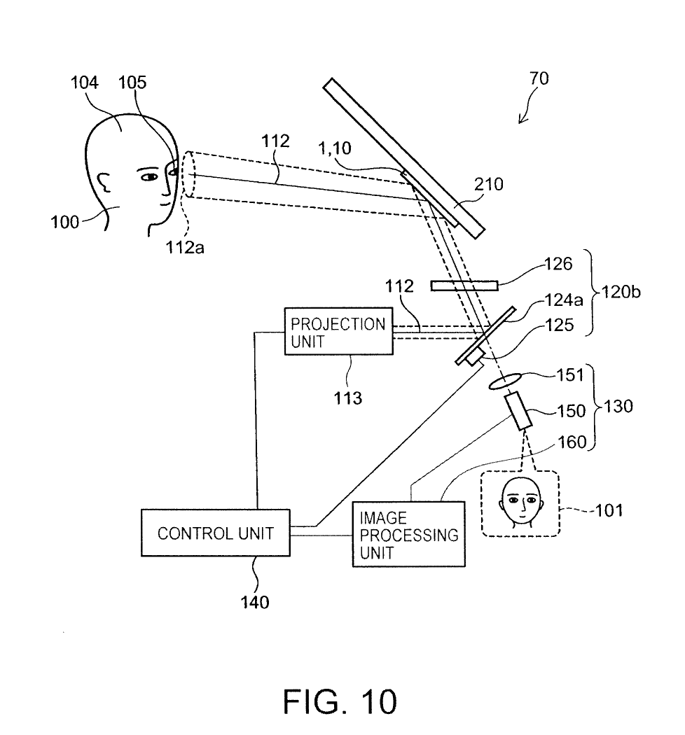

FIG. 10 is a diagram illustrating by way of example a display device according to a seventh embodiment.

As shown in FIG. 10, the display device 70 comprises a flux control unit 120b. Also, in the flux control unit 120b, there is provided a second mirror 124a that is capable of reflecting part of the incident optical flux and transmitting part thereof. Also, an image pickup unit 150 is provided at the rear face side of the second mirror 124a. Consequently, the image pickup unit 150 can pick up an image 101 of the observer 100 obtained by transmission through the second mirror 124a.

In this case, preferably the second mirror 124a can reflect visible light and transmit infrared light. Also, preferably the image pickup unit 150 can pick up an image 101 of the observer 100 by means of infrared light. With such a construction, unwanted noise in the image can be reduced.

It should be noted that, although, in the above embodiments, the case was described by way of example in which the image pickup unit 150 was provided at the rear face side of the first mirror 122 or second mirror 124a, it suffices if the image pickup unit 150 is provided on the line of the extension of the optic axis of the optical flux 112 in a position where it is capable of picking up an image 101. Also, for example, the image pickup unit 150 may be provided at a position where it is capable of directly picking up an image of the observer 100.

Also, in the case where the display device according to the various embodiments described above is employed in a condition in which for example the attitude of the observer is substantially fixed, as in the case of a head-up display (HUD), the shape of the display region 112a can also be made to be a vertically elongate shape (shape that is elongate in a substantially vertical direction). In this way, it can be arranged for positional alignment of the position of the eye 105 and the position of the display region 112a to be performed solely in the horizontal direction. Consequently, not only does positional control of the display region 112a become easy, but also ease of use is achieved and, in addition, costs can be lowered.

Also, in the display devices of the various embodiments described above, the projection plate 210 illustrated by way of example could be embodied by for example the windshield provided in a movable body such as an automobile. Tf the projection plate 210 is for example a windshield, various types of video information (such as for example travel information etc) can be arranged to be displayed on the windshield superimposed on an image of the external background field of view of the windshield. The driver can therefore recognize the video information without having to move his/her line of vision (or line of sight) far. Also, recognizability can be improved, since distortion of the image of the external background field of view can be suppressed.

Next, an example of a movable body according to this embodiment will be illustrated.

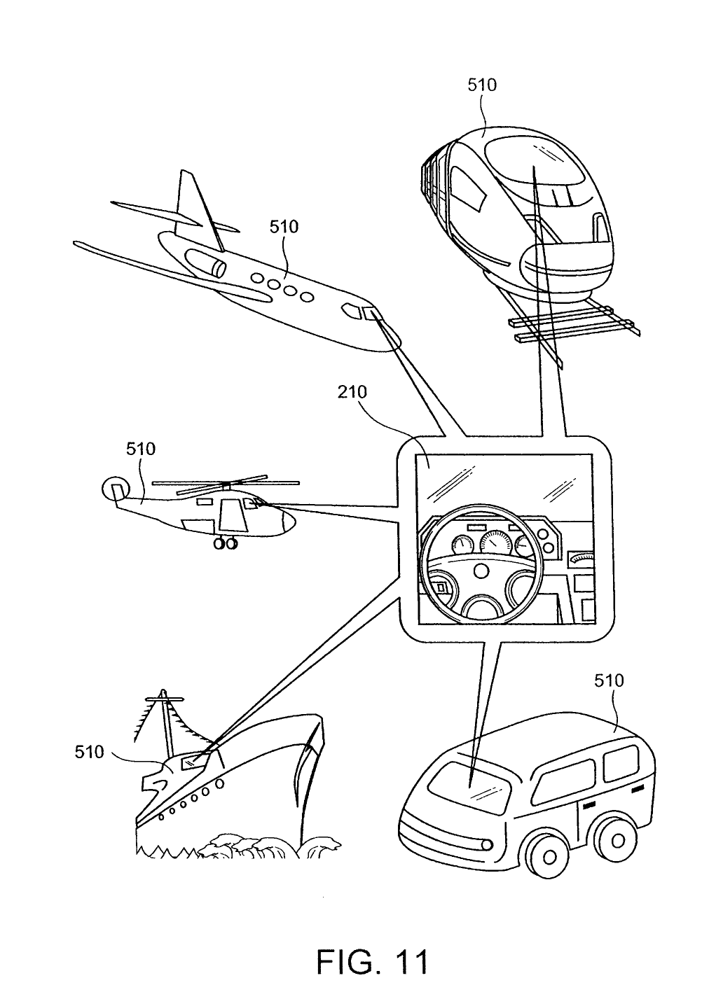

FIG. 11 is a diagram illustrating by way of example a movable body according to this embodiment.

As shown in FIG. 11, for example the window of various types of movable body 510 such as for example an automobile, train, ship, helicopter or airplane can be employed as the projection plate 210. Specifically, a movable body can be constituted comprising a display device according to this embodiment and a projection plate 210 on which is projected various types of video information (such as for example travel information) using this display device.

With this embodiment, distortion of the image of the external background field of view can be suppressed, so recognizability can be improved. Also, by analyzing the position of the eye of the observer 100 using the image processing unit 160, the optical flux can be directed onto the position thereof. Consequently, a movable body can be provided that can be operated with safety and high efficiency.

The present embodiments were given by way of example. However, the invention is not restricted to these as described.

Suitable design modifications may be made by persons skilled in the art in relation to the embodiments described above and are included within the scope of the present invention so long as they provide the features of the present invention.

For example, the shape, size, materials, arrangement and number etc of the various elements provided by the display device 20, display device 30, display device 40, display device 60 and display device 70 are not restricted to those illustrated by way of example and can be suitably altered.

Also, the various elements provided by the embodiments described above can be combined so far as possible, and the resulting combinations thereof are included in the scope of the present invention provided that they include the features of the present invention.

What is claimed is:

1. An optical member comprising:
(1) a first optical layer having:
(a) a first main face formed with a concave section having a concave curved surface, and a plurality of convex ridges having concave curved surfaces provided in concentric circular fashion around said concave section; and
(b) a second main face formed with: a convex section having a convex curved surface that is provided facing said concave section and constituting said second main face facing said first main face; and a plurality of convex ridges having convex curved surfaces provided facing the plurality of convex ridges having said concave curved surface, provided in concentric circular fashion around said convex section; and
(2) a second optical layer provided on the first main face of said first optical layer; and
(3) a third optical layer provided on the second main face of said first optical layer,
wherein a refractive index of said first optical layer is higher than a refractive index of said second optical layer and is higher than a refractive index of said third optical layer.

2. The optical member according to claim 1,
wherein a curvature dimension of said concave curved surface and a curvature dimension of said convex curved surface provided in mutually facing positions are substantially the same.

3. The optical member according to claim 1 or claim 2,
wherein a refractive index of said second optical layer and a refractive index of said third optical layer are substantially the same.

4. An optical member comprising:
(4) a fourth optical layer having: a main face formed with a concave section having a concave curved surface, and a plurality of convex ridges having concave curved surfaces provided in concentric circular fashion around said concave section;
(5) a semi-transparent layer provided on said main face of said fourth optical layer; and
(6) a fifth optical layer provided on a main face on an opposite side to said fourth optical layer of said semi-transparent layer,
wherein a refractive index of said fourth optical layer and a refractive index of said fifth optical layer are substantially the same.

5. The optical member according to claim 4,
wherein said semi-transparent layer reflects part of an incident optical flux.

6. A display device comprising:
an optical member according to anyone of claims 1 to 5; and
a projection unit whereby optical flux is directed onto said optical member.

7. The display device according to claim 6,
wherein said projection unit directs optical flux onto a main face on a side of said optical member where a concave curved surface is provided.

8. The display device according to claim 6, further comprising:
an image pickup unit that picks up an image of an observer; and
an optical flux control unit that directs said optical flux onto a position of a specified part of said observer, by using an image picked up by said image pickup unit.

9. The display device according to claim 7, further comprising:
an image pickup unit that picks up an image of an observer; and
an optical flux control unit that directs said optical flux onto a position of a specified part of said observer, by using an image picked up by said image pickup unit.

10. A movable body comprising:
a display device according to any one of claims 6 to 8; and
a projection plate onto which video information is projected by said display device.
